(19) United States
(12) Patent Application Publication
(10) Pub. No.: US 2026/0152818 A1
(43) Pub. Date: Jun. 4, 2026

(54) COMPOSITE MATERIAL

(71) Applicant: BASF SE, Ludwigshafen am Rhein (DE)

(72) Inventors: Marc DUCHARDT, Ludwigshafen (DE); Wolfram WILK, Ludwigshafen (DE); Fabian SEELER, Ludwigshafen (DE); Maximilian RANG, Ludwigshafen (DE); Wolfgang ROHDE, Ludwigshafen (DE); Kerstin SCHIERLE-ARNDT, Ludwigshafen (DE); Anne-Marie Caroline ZIESCHANG, Ludwigshafen (DE); Julian Duane ESPER, Ludwigshafen (DE)

(21) Appl. No.: 19/122,784

(22) PCT Filed: Oct. 31, 2023
(86) PCT No.: PCT/EP2023/080407

§ 371 Date: Apr. 21, 2025

(30) Foreign Application Priority Data
Nov. 3, 2022 (EP) 22205378.7

(51) Int. Cl. C22B 1/02; C22B 7/00; H01M 10/54

(52) U.S. Cl. CPC C22B 1/02; C22B 7/007; H01M 10/54

(57) ABSTRACT

Disclosed herein is a composite material (pyrolyzed black mass) including valuable metals, such as nickel, cobalt, manganese, lithium, aluminum, and copper, and having improved processibility and/or metal recovery in processes for recycling and/or recovery of the valuable metals. The composite material is a useful intermediate in the recycling of lithium ion batteries. Also disclosed herein is a process for producing the composite material from lithium ion batteries.

### FIELD OF THE INVENTION

Disclosed is a composite material (pyrolyzed black mass) comprising valuable metals, e.g., nickel, cobalt, manganese, lithium, aluminum, and copper, and having improved processibility and/or metal recovery in processes for recycling and/or recovery of the valuable metals. The composite material is a useful intermediate in the recycling of lithium ion batteries. Also disclosed is a process for producing the composite material from lithium ion batteries.

### BACKGROUND

Lithium ion battery materials are complex mixtures of various elements and compounds. For example, many lithium ion battery materials contain valuable metals such as lithium, aluminum, copper, nickel, cobalt, and/or manganese. It may be desirable to recover various elements and compounds from lithium ion battery materials. For example, it may be advantageous to recover lithium, aluminum, copper, nickel, cobalt, and/or manganese. In some battery recycling processes, different process parameters may produce intermediate materials having different compositions and/or properties. Intermediate materials having, for example, a favorable composition, mechanical properties, surface hydrophilicity, and/or porosity may, e.g., result in improved processibility and/or recovery in subsequent downstream processing steps. Such downstream processing steps may, for example, be part of a lithium ion battery recycling process and/or more general metal recycling and/or recovering steps.

Accordingly, there is a need for materials having improved processibility and/or metal recovery in subsequent downstream recycling and/or recovery processes. For example, there is a need for intermediate lithium ion battery recycling materials having, for example, a favorable composition, mechanical properties, surface hydrophilicity, and/or porosity. Further, there is a need for improved battery recycling processes for producing such improved intermediate materials.

WO 2020/109045 A1 discloses a process for the recovery of transition metals from batteries comprising (a) treating a transition metal material with a leaching agent to yield a leach which contains dissolved salts of nickel and/or cobalt, (b) injecting hydrogen gas in the leach at a temperature above 100° C. and a partial pressure above 5 bar to precipitate nickel and/or cobalt in elemental form, and (c) separation of the precipitate obtained in step (b). The transition metal material is obtained from mechanically treated battery scrap, or it is obtained as metal alloy from smelting battery scrap.

CN 110085819 A discloses a sodium-doped potassium-based cyanidation frame composite material for a potassium ion battery electrode and a preparation method thereof. The sodium-doped potassium-based cyanidation frame composite material includes a sodium-doped potassium-based cyanidation framework material and a fluorine-containing compound, wherein a chemical formula of the sodium-doped potassium-based cyanidation framework material is Na_{y}KₓMnFe(CN)₆, the x is not smaller than 1.5 and is not greater than 2.0, y/x is greater than 0.01 and is not greater than 0.1, and the fluorine-containing material is selected from a carbon fluoride material or a metal fluoride. The sodium-doped potassium-based cyanidation frame composite material is made from a sodium-based cyanidation frame material as a raw material by incomplete ion exchange reaction, and the sodium-doped potassium-based cyanidation frame material is then combined with the fluorine-containing material.

US 2022/251681 A1 discloses a process for the recovery of one or more transition metals and lithium from waste lithium ion batteries or parts thereof. The process comprising the steps of (a) providing a particulate material containing a transition metal compound and/or transition metal, wherein the transition metal is selected from the group consisting of Ni and Co, and wherein further at least a fraction of said Ni and/or Co, if present, are in an oxidation state lower than +2, e.g. in the metallic state; which particulate material further contains a lithium salt; (b) treating the material provided in step (a) with a polar solvent and optionally an alkaline earth hydroxide; (c) separating the solids from the liquid, optionally followed by a solid-solid separation step; and (d) treating the solids containing the transition metal in a way to dissolve at least part of the Ni and/or Co, typically using a mineral acid.

### SUMMARY OF THE INVENTION

A composite material (pyrolyzed black mass) comprising lithium, fluorine and at least one of nickel, cobalt, manganese, and iron is provided, which has a fluorine content of from 1 to 10 wt.-%, relative to the total weight of the composite material. The ratio of total fluorine content to ionic fluorine (fluoride) content of the composite material is less than 1.1.

A process for preparing the composite material also is provided. The process comprises providing an intermediate lithium ion battery recycling material comprising a cathode active material (CAM) and at least one fluoropolymer at a first temperature; heating the intermediate lithium ion battery recycling material at a second temperature ranging from 520° C. to 630° C.; contacting the intermediate lithium ion battery recycling material with an inert gas and with a reductive gas generated in situ by thermal decomposition of the intermediate lithium ion battery recycling material to obtain the composite material; and optionally, cooling the composite material to a third temperature ranging from 10° C. to 100° C.

Further, the use of the composite material in the recovery of valuable materials from lithium ion batteries is provided.

### BRIEF DESCRIPTION OF THE DRAWINGS

FIG. 1 shows an exemplary process for preparing an exemplary composite material from a lithium ion battery material.

FIG. 2 shows an exemplary downstream process for recovering value metals from an exemplary composite material.

### DEFINITIONS

As used herein, the term “composite material” refers to a material comprising two or more different constituents.

As used herein, the term “intermediate lithium ion battery recycling material” refers to a material obtainable by mechanical processing of lithium ion batteries or battery scrap and comprising a cathode active material (CAM) and at least one fluoropolymer.

As used herein, a “reductive gas” is a gas capable of reducing a metal oxide and/or a metal hydroxide. For example, some reducing agents are capable of reducing some metal oxides and/or some metal hydroxides but not others.

Unless otherwise stated, all temperatures refer to the temperature of the environment in which a material is located and may or may not be different from the temperature of the material itself.

### DETAILED DESCRIPTION OF THE DRAWINGS

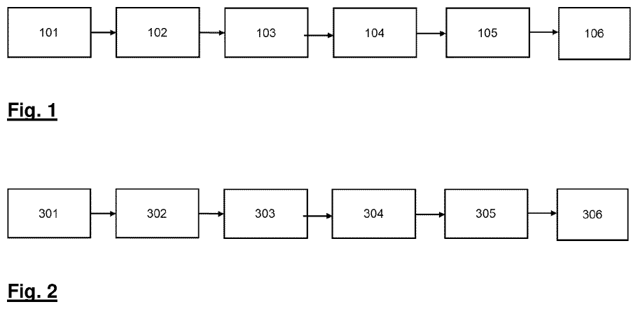

FIG. 1 depicts an exemplary process for preparing an exemplary composite material from a lithium ion battery material. In Steps 101 and 102, the lithium ion battery is discharged and dismantled to obtain a lithium ion battery material. In Step 103, the lithium ion battery material is shredded. The shredded lithium ion battery material is dried in step 104 to remove solvent and sieved in step 105 before being subjected to a pyrolysis process in step 106.

FIG. 2 depicts an exemplary downstream process for recovering value metals from an exemplary composite material. After pyrolysis in step 301, the aluminum composite material is leached in an acid solution in step 302, copper is extracted in an optional step 303, and various impurities, for instance, manganese, may then be removed in step 304 by precipitation as insoluble manganese salt. Subsequently, nickel and/or cobalt are extracted in step 305 and lithium is recovered in step 306. Alternatively, manganese may also be recovered together with nickel and/or cobalt in step 305.

### DETAILED DESCRIPTION

### Composite Material

The present disclosure provides a composite material comprising lithium, fluorine, and at least one of nickel, cobalt, manganese, and iron. The composite material has a fluorine content of from 1 to 10 wt.-%, e.g., from 1 to 8 wt.-%, for instance, from 1 to 5 wt.-%, from 2 to 4 wt.-%, or from 2 to 3 wt.-%, relative to the total weight of the composite material. The ratio of total fluorine content to ionic fluorine (fluoride) content of the composite material is less than 1.1. In some embodiments, the ratio is less than 1.05. In a particular embodiment, the ratio is approximately 1.0, i.e., the composite material only comprises inorganic fluorides and no organic fluoro compounds or compounds comprising carbon-fluorine bonds.

Without wishing to be bound by theory, it is believed that the near complete conversion of the fluorine contained in the intermediate lithium ion battery recycling material to fluoride, i.e., having a ratio of total fluorine content to ionic fluorine (fluoride) content of the composite material of less than 1.1, results in a composite material having favorable properties.

For instance, the composite material of the present disclosure leads to clear phase separation when it is dispersed in a suitable solvent extraction reagent, while composite materials featuring a ratio of total fluorine content to ionic fluorine (fluoride) content of more than 1.1 show strong crud formation. A further benefit is that no flotation additives are required in the downstream leaching process.

In some embodiments, the composite material comprises from 0 to 45 wt.-%, e.g., 0 to 35 wt.-%, for instance, from 11 to 26 wt.-%, of nickel, based on the total weight of the composite material.

In some embodiments, the composite material comprises from 0 to 45 wt.-%, e.g., 0 to 33 wt.-%, for instance, from 3 to 30 wt.-%, of cobalt, based on the total weight of the composite material.

In some embodiments, the composite material comprises from 0 to 45 wt.-%, e.g., 0 to 15 wt.-%, for instance, from 3 to 11 wt.-%, of manganese, based on the total weight of the composite material.

In some embodiments, the composite material comprises from 0.01 to 2.0 wt.-%, for instance, from 0.1 to 0.5 wt.-%, of iron, based on the total weight of the composite material.

In some embodiments, the composite material comprises from 2 to 6 wt.-%, for instance, from 3.5 to 4 wt.-%, of lithium, based on the total weight of the composite material.

In some embodiments, the composite material further comprises aluminum and/or copper and/or carbon and/or phosphorus.

In some embodiments, the composite material comprises from 1 to 12 wt.-%, for instance, from 1 to 5 wt.-%, of aluminum, based on the total weight of the composite material.

In some embodiments, the composite material comprises from 0.5 to 8 wt.-%, for instance, from 1 to 5 wt.-%, of copper, based on the total weight of the composite material.

In some embodiments, the composite material comprises from 0.2 to 2.0 wt.-%, for instance, from 0.5 to 1 wt.-%, of phosphorus, based on the total weight of the composite material.

In some embodiments, the composite material comprises almost no carbon (only conductive carbon in the cathode). In some other embodiments, the composite material comprises approximately 30 wt.-% carbon, based on the total weight of the composite material. In some embodiments, the carbon takes the form of graphite.

### Process for Preparing Composite Materials

The present disclosure also provides a process for preparing the composite material. The process comprises
a) providing an intermediate lithium ion battery recycling material comprising a cathode active material (CAM) and at least one fluoropolymer at a first temperature;
b) heating the intermediate lithium ion battery recycling material at a second temperature ranging from 520° C. to 630° C.;
c) contacting the intermediate lithium ion battery recycling material with an inert gas and with a reductive gas generated in situ by thermal decomposition of the intermediate lithium ion battery recycling material to obtain the composite material;
d) optionally, cooling the composite material to a third temperature ranging from 10° C. to 100° C.

### Intermediate Lithium Ion Battery Recycling Materials

Lithium ion batteries may be disassembled, punched, milled, for example in a hammer mill, rotor mill, and/or shredded, for example in an industrial shredder. From this kind of mechanical processing the active material of the battery electrodes may be obtained. A light fraction such as housing parts made from organic plastics and aluminum foil or copper foil may be removed, for example, in a forced stream of gas, air separation or classification or sieving.

Battery scraps may stem from, e.g., used batteries or from production waste such as off-spec material. In some embodiments a material is obtained from mechanically treated battery scraps, for example from battery scraps treated in a hammer mill a rotor mill or in an industrial shredder. Such material may have an average particle diameter (D₅₀), measured as described below, ranging from 1 μm to 1 cm, such as from 1 μm to 500 μm, and further for example, from 3 μm to 250 μm.

Larger parts of the battery scrap like the housings, the wiring and the electrode carrier films may be separated mechanically such that the corresponding materials may be excluded from the battery material that is employed in the disclosed process. In some embodiments, the separation is done by manual or automated sorting. For example, magnetic parts can be separated by magnetic separation, non-magnetic metals by eddy-current separators. Other techniques may comprise jigs and air tables.

Mechanically treated battery scrap may be subjected to a solvent treatment in order to dissolve and separate polymeric binders used to bind the transition metal oxides to current collector films, or, e.g., to bind graphite to current collector films. Examples of suitable solvents include, but are not limited to, N-methylpyrrolidone, N,N-dimethylformamide, N,N-dimethylacetamide, N-ethyl-pyrrolidone, and dimethylsulfoxide, in pure form, as mixtures of at least two of the foregoing, or as a mixture with 1% to 99% by weight of water; by total weight of the mixture.

In some embodiments, the intermediate lithium ion battery recycling material shows a particle size distribution, determined by laser light scattering as described below, having a D(10) value in the range of from 2 to 6 μm, e.g., from 4 to 5 μm, a D(50) value in the range of from 10 to 30 μm, and a D(90) value in the range of from 150 to 250 μm. In some embodiments, the intermediate lithium ion battery recycling material has a D(10) value in the range of from 4 to 4.5 μm, a D(50) value in the range of from 20 to 25 μm, and a D(90) value in the range of from 200 to 210 μm. In particular embodiments, the intermediate lithium ion battery recycling material has a D(10) value of 4.2 μm, a D(50) value of 22.4 μm, and a D(90) value of 203 μm. In other embodiments, the intermediate lithium ion battery recycling material has a D(10) value in the range of from 4 to 4.5 μm, a D(50) value in the range of from 12 to 16 μm, and a D(90) value in the range of from 140 to 170 μm. In particular embodiments, the intermediate lithium ion battery recycling material has a D(10) value of 4.2 μm, a D(50) value of 14.1 μm, and a D(90) value of 158 μm.

For example, the particle size distribution can be measured by dispersing a sample of the intermediate lithium ion battery recycling material in water comprising a non-ionic surfactant and measuring the dispersion in a laser diffraction particle size analyzer, e.g., a Mastersizer® 3000, Malvern Panalytical GmbH, 34123 Kassel, Germany) coupled to an automated dispersion unit (Hydro MV, Malvern Panalytical GmbH, 34123 Kassel, Germany). In a specific example, the sample is dispersed in 120 ml water comprising 1-2 ml of a polyethylene glycol ether (0.5 wt.-% solution of Lutensol® XL 80, BASF SE), stirring at 3500 rpm and using 2 min of ultrasound sonification.

In some embodiments, the intermediate lithium ion battery recycling material comprises nickel, cobalt, manganese, copper, aluminum, iron, phosphorus, or combinations thereof.

In some embodiments of the process, the provided intermediate lithium ion battery recycling material comprises an aluminum foil and a cathode active material and is obtained by a process comprising: shredding a battery material, and drying the shredded battery material.

In some embodiments, a process for recycling lithium ion battery materials comprises mechanically comminuting at least one chosen from a lithium ion battery, lithium ion battery waste, lithium ion battery production scrap, lithium ion cell production scrap, lithium ion cathode active material, and combinations thereof.

In some embodiments, the intermediate lithium ion battery recycling material comprises from 1 weight-% to 20 weight-% aluminum in a zero oxidation state as aluminum foil, based on the total weight of the intermediate lithium ion battery recycling material. In some embodiments, the intermediate lithium ion battery recycling material comprises from 1 weight-% to 10 weight-% aluminum in a zero oxidation state as aluminum foil, based on the total weight of the intermediate lithium ion battery recycling material. In some embodiments, the intermediate lithium ion battery recycling material comprises from 2 weight-% to 6 weight-% in a zero oxidation state as aluminum foil, based on the total weight of the intermediate lithium ion battery recycling material. In some embodiments, the intermediate lithium ion battery recycling material comprises from 2 weight-% to 5 weight-% in a zero oxidation state as aluminum foil, based on the total weight of the intermediate lithium ion battery recycling material.

The intermediate lithium ion battery recycling material used in the process of the present disclosure comprises a cathode active material (CAM) and at least one fluoropolymer. In some embodiments of the process, the at least one fluoropolymer comprises polyvinylidene fluoride (PVDF). In some embodiments of the process, the at least one fluoropolymer comprises polytetrafluoroethylene (PTFE). In some embodiments of the process, the intermediate lithium ion battery recycling material also comprises LiPF₆.

### Cathode Active Material

The intermediate lithium ion battery recycling material used in the process of the present disclosure comprises a cathode active material (CAM). In some embodiments of the process, the cathode active material is of formula LiₚM_{q}M′ᵣOₛ. In some embodiments, M comprises one or more metals chosen from nickel, manganese, and cobalt, M′ comprises one or more metals chosen from Mg, Ca, Ba, Al, Ti, Zr, Zn, Fe, V, Mo, and W; p ranges from 1 to 1.4; q ranges from 0.6 to 2; r ranges from 0 to 1; s ranges from 2 to 4.

In some embodiments, the cathode active material comprises lithiated nickel cobalt manganese oxide of formula Li₍₁₊ₓ₎(NiₐCo_{b}Mn_{c}M_{d})₍₁₋ₓ₎O₂, wherein: M is chosen from Mg, Ca, Ba, Al, Ti, Zr, Zn, Mo, V and Fe; zero≤x≤0.2; 0.1≤a≤0.95, zero≤b≤0.9, or 0.05<b≤0.5; zero≤c≤0.6; zero≤d≤0.1; and a+b+c+d=1.

In some embodiments, the cathode active material comprises lithiated nickel-cobalt aluminum oxides of formula Li[NiₕCoⱼAlⱼ]O₂₊ₜ, wherein: h ranges from 0.8 to 0.95; i ranges from 0.1 to 0.3; j ranges from 0.01 to 0.10; and t ranges from zero to 0.4.

In some embodiments, the cathode active material comprises lithiated manganese oxides of formula Li₍₁₊ₓ₎Mn_{2-x-y-z}M_{y}M′_{z}O₄, wherein: x ranges from zero to 0.2; y+z ranges from zero to 0.1; and M′ is chosen from Al, Mg, Fe, Ti, V, Zr and Zn.

In some embodiments, the cathode active material comprises a compound of formula xLi_{(1+1/3)}M_{(2/3)}O₂·yLiMO₂·zLiM′O₂, wherein M comprises at least one metal of Mn, Ni, Co of oxidation state +4, M′ is at least one transition metal and

$$0 < x < 1 , 0 < y < 1 , 0 < z < 1 and x + y + z = 1.$$

In some embodiments, the cathode active material comprises at least one cathode active material chosen from lithiated nickel cobalt manganese oxide, lithiated nickel cobalt aluminum oxide, lithiated manganese oxide, lithium ion battery scrap comprising cathode active materials such as production waste from the production of cathode active materials, and combinations thereof.

In some embodiments the cathode active material comprises lithiated nickel cobalt manganese oxide of formula Li₁₊ₓ(NiₐCo_{b}Mn_{c}M¹_{d})₁₋ₓO₂, wherein M¹ is chosen from Mg, Ca, Ba, Al, Ti, Zr, Zn, Mo, V and Fe, zero≤x≤0.2, 0.1≤a≤0.95, zero≤b≤0.9 (such as 0.05<b≤0.5), zero≤c≤0.6, zero≤d≤0.1, and a+b+c+d=1. Exemplary lithiated nickel cobalt manganese oxides include Li₍₁₊ₓ₎[Ni_{0.33}Co_{0.33}Mn_{0.33}]₍₁₋ₓ₎O₂, Li₍₁₊ₓ₎[Ni_{0.5}Co_{0.2}Mn_{0.3}]₍₁₋ₓ₎O₂, Li₍₁₊ₓ₎[Ni_{0.6}Co_{0.2}Mn_{0.2}]₍₁₋ₓ₎O₂, Li₍₁₊ₓ₎[Ni_{0.7}Co_{0.2}Mn_{0.3}]₍₁₋ₓ₎O₂, Li₍₁₊ₓ₎[Ni_{0.8}Co_{0.1}Mn_{0.1}]₍₁₋ₓ₎O₂ each with x as defined above, and Li[Ni_{0.85}Co_{0.13}Al_{0.02}]O₂.

In some embodiments, the cathode active material comprises lithiated nickel-cobalt aluminum oxides of formula Li[NiₕCoⱼAlⱼ]O₂₊ₜ, wherein h ranges from 0.8 to 0.95, i ranges from 0.1 to 0.3, j ranges from 0.01 to 0.10, and t ranges from zero to 0.4.

In some embodiments, the cathode active material comprises LiₓMO₂; wherein x is an integer greater than or equal to one, and M is chosen from metals, transition metals, rare earth metals, and combinations thereof.

In some embodiments, the cathode active material comprises lithiated manganese oxides of formula Li₍₁₊ₓ₎Mn_{2-x-y-z}M_{y}M′_{z}O4, wherein: x ranges from zero to 0.2; y+z ranges from zero to 0.1; and M′ is chosen from Al, Mg, Fe, Ti, V, Zr and Zn.

In some embodiments, the cathode active material comprises a compound of formula xLi_{(1+1/3)}M_{(2/3)}O₂·yLiMO₂·zLiM′O₂, wherein M comprises at least one metal of Mn, Ni, Co of oxidation state +4, M′ is at least one transition metal and

$$0 < x < 1 , 0 < y < 1 , 0 < z < 1 and x + y + z = 1.$$

In some embodiments, the cathode active material comprises LiCoO₂. In some embodiments, the cathode active material comprises LiFePO₄.

In some embodiments, the cathode active material is prepared according to a process disclosed in WO 2019/011 786 A1; the disclosure of which is herein incorporated by reference in its entirety.

In some embodiments, the cathode active material is prepared by a process for making an electrode active material according to general formula Li₁₊ₓTM₁₋ₓO₂, wherein TM is a combination of metals comprising Mn, Co, and Ni and at least one metal M chosen from Al, Ti, and W, wherein at least 60 mole-% of TM is Ni, the percentage referring to the sum of Ni, Co, and Mn, and x ranges from zero to 0.2, wherein the process comprises: (a) mixing (A) a mixed oxide or mixed oxyhydroxide of Mn, Co, and Ni, and (B) at least one lithium compound chosen from lithium hydroxide, lithium oxide and lithium carbonate, and (C) an oxide, hydroxide or oxyhydroxide of Al, Ti, or W, (b) subjecting the mixture to heat treatment at a temperature in the range of from 700° C. to 1000° C.

In some embodiments, the cathode active material is prepared by a process wherein TM in the electrode active material is a combination of metals according to general formula (I) (NiₐCo_{b}Mn_{c})_{1-d}M_{d} (I) with a ranging from 0.6 to 0.85, b ranging from 0.05 to 0.2, c ranging from 0.05 to 0.2, and d ranging from 0.005 to 0.1, and M is Al, and a+b+c=1.

In some embodiments, the cathode active material has a surface (BET) ranging from 0.1 m²/g to 0.8 m²/g, determined according to DIN-ISO 9277:2003-05.

In some embodiments, the process of the present disclosure comprises providing an intermediate lithium ion battery recycling material comprising a cathode active material (CAM) and at least one fluoropolymer at a first temperature; heating the intermediate lithium ion battery recycling material at a second temperature ranging from 520° C. to 630° C., for instance, from 550° C. to 600° C.; contacting the intermediate lithium ion battery recycling material with an inert gas and with a reductive gas generated in situ by thermal decomposition of the intermediate lithium ion battery recycling material to obtain the composite material; and optionally cooling the composite material to a third temperature ranging from 10° C. to 100° C., e.g., from 20° C. to 70° C.

In some embodiments, the process of the present disclosure comprises providing an intermediate lithium ion battery recycling material comprising a cathode active material (CAM) and at least one fluoropolymer at a first temperature. In some embodiments of the process, the first temperature ranges from −50° C. to 50° C., e.g., from −10° C. to 40° C., for instance, from 0° C. to 30° C. In a particular embodiment, the first temperature is ambient temperature.

In some embodiments, the process of the present disclosure comprises heating the intermediate lithium ion battery recycling material at a second temperature ranging from 520° C. to 630° C. In some embodiments of the process, the second temperature ranges from 530° C. to 600° C. In further embodiments, the second temperature ranges from 550° C. to 580° C.

In some embodiments of the process, the heating step comprises a temperature ramp from the first temperature to the second temperature over a period of 10 minutes to 2 hours. In some embodiments of the process, the heating step comprises a temperature ramp from the first temperature to the second temperature over a period of 30 minutes to 1 hour.

In some embodiments, a temperature ramp has average rate of temperature increase of at least 5 K per minute. In some embodiments, a temperature ramp has average rate of temperature increase of at least 10 K per minute. In some embodiments, a temperature ramp has average rate of temperature increase of at least 15 K per minute. In some embodiments, a temperature ramp has average rate of temperature increase of at least 20 K per minute. In some embodiments, a temperature ramp has average rate of temperature increase of at least 25 K per minute. In some embodiments, a temperature ramp has average rate of temperature increase of up to 50 K per minute.

In some embodiments, a temperature ramp has average rate of temperature increase ranging from 5 K per minute to 50 K per minute. In some embodiments, a temperature ramp has average rate of temperature increase ranging from 10 K per minute to 50 K per minute.

In some embodiments of the process, the heating step comprises dwelling at the second temperature for a period of time ranging from 0 minutes to 1 hour, for instance, from 10 minutes to 45 minutes, or from 15 minutes to 30 minutes.

In some embodiments of the process, the heating step comprises dwelling at one or more intermediate temperatures ranging from the first temperature to the second temperature.

In some embodiments, a process for preparing a composite material comprises: providing an intermediate lithium ion battery recycling material comprising a cathode active material and at least one fluoropolymer at a first temperature ranging from −50° C. to 50° C.; heating the intermediate lithium ion battery recycling material at a second temperature ranging from 520° C. to 630° C.; wherein the heating step comprises a temperature ramp from the first temperature to the second temperature over a period of time ranging from 10 minutes to 1 hour; dwelling at the second temperature for a time ranging from 0 minutes to 1 hour; and, optionally, cooling the material to a third temperature ranging from 50° C. to 70° C.

In some embodiments, the process of the present disclosure comprises contacting the intermediate lithium ion battery recycling material with an inert gas and with a reductive gas generated in situ by thermal decomposition of the intermediate lithium ion battery recycling material to obtain the composite material.

In some embodiments, the flow rate of the inert gas is in the range of from 100 to 300 Sm³/h, e.g. 150 to 250 Sm³, for instance, 200 Sm³/h (standard cubic meter per hour).

In some embodiments, the inert gas comprises at least one gas chosen from argon (Ar), dinitrogen (N₂), helium (He), and mixtures thereof.

In some embodiments, the reductive gas comprises at least one gas chosen from the group of hydrocarbons, dihydrogen gas (H₂), carbon monoxide (CO), and mixtures thereof.

In some embodiments of the process, the reductive gas comprises: from 5 volume % to 70 volume % C₁ to C₁₀ hydrocarbons, from 5 volume % to 95 volume % carbon dioxide (CO₂), from 0.1 volume % to 10 volume % carbon monoxide (CO), and from 0.1 volume % to 15 volume % H₂; wherein each volume % is by total volume of the reductive gas and the volume % of C₁ to C₁₀ hydrocarbons plus the volume % of CO₂ plus the volume % of H₂ is less than or equal to 100%.

In some embodiments of the process, the reductive gas comprises: from 5 volume % to 70 volume % C₁ to C₁₀ hydrocarbons, from 5 volume % to 45 volume % C₁ to C₁₀ oxy-hydrocarbons, and from 0.1 volume % to 15 volume % H₂; wherein each volume % is by total volume of the reductive gas and the volume % of C₁ to C₁₀ hydrocarbons plus the volume % C₁ to C₁₀ oxy-hydrocarbons plus the volume % of H₂ is less than or equal to 100%.

In some embodiments of the process, the heating step is performed in a rotary kiln. The rotary kiln is a cylindrical vessel, inclined slightly from the horizontal, which is rotated slowly about its longitudinal axis. The process feedstock is fed into the upper end of the cylinder. As the kiln rotates, material gradually moves down toward the lower end, and may undergo a certain amount of stirring and mixing.

In some embodiments of the process, the kiln has a length in the range of from 14 m to 18 m. In some embodiments of the process, the kiln has a length in the range of from 15 m to 17 m. Kiln length refers to the length of the heated zone of the kiln. Additional elements will make the overall kiln a little bit longer. In some embodiments of the process, the inner diameter of the cylindrical tube is in the range of from 1.4 m to 2.2 m, e.g., from 1.7 m to 1.9 m.

In some embodiments of the process, the kiln is filled with a volume of intermediate lithium ion battery recycling material equal to 5 to 20%, e.g., from 7% to 16%, for instance, from 9% to 12%, of the total volume of the kiln.

In some embodiments of the process, the intermediate lithium ion battery recycling material is fed to the kiln using at least one screw conveyor.

In some embodiments of the process, the kiln rotates at 0.5 to 3 rpm. In some embodiments of the process, the kiln rotates at 1.4 to 2.6 rpm. In some embodiments of the process, the kiln rotates at 1.8 to 2.2 rpm.

In some embodiments of the process, overpressure is maintained in the kiln during operation to prevent air from entering the kiln.

In some embodiments of the process, hot gases pass along the kiln in the same direction as the process material (concurrent). In some embodiments of the process, the intermediate lithium ion battery recycling material and an inert gas are fed to the rotary kiln in concurrent flow. The concurrent flow makes sure that no dust accumulates at or emerges from the upper end of the kiln. Further, the concurrent flow also prevents the condensation of high-boiling constituents of the gas atmosphere present in the kiln on the kiln wall near the inlet where temperature in the kiln is lowest.

In some embodiments of the process, the rotary kiln is heated by external heating elements using electric power. In some embodiments of the process, the kiln comprises several heating zones. In some embodiments of the process, each and every heating zone is operated at a temperature in the range of from 520 to 600° C. In some embodiments, thermoelements are provided in each of the heating zones for measuring the temperature in the respective zone. In one embodiment, each heating zone has a length of from 0.5 m to 6 m, e.g., 1 m to 4 m, for instance, 1.5 m to 3 m.

In some embodiments of the process, the kiln connects with a material exit hood at the lower end and ducts for waste gases. This requires gas-tight seals at either end of the kiln. The exhaust gas contains hydrocarbons. Equipment is installed to eliminate these from the gas stream before passing to the atmosphere.

In some embodiments, the process of the present disclosure involves cooling the composite material obtained to a third temperature ranging from 10° C. to 100° C., e.g., from 20° C. to 50° C. In some embodiments, cooling is performed in a rotary cooler positioned at the lower end of the rotary kiln. In some embodiments, the rotary cooler has the same diameter as the rotary kiln and is cooled by a water jacket. In some embodiments of the process the inside of the rotary cooler is flushed with an inert gas, e.g., nitrogen gas.

In some embodiments of the process, the composite material exiting the rotary kiln falls into the rotary cooler, while exhaust gas leaving the rotary kiln is drawn off without being cooled. This prevents condensation of hydrocarbons present in the exhaust gas onto the composite material.

As provided herein, different process parameters may produce intermediate materials having different compositions and/or properties. Intermediate materials having, for example, a favorable composition, mechanical properties, surface hydrophilicity, and/or porosity may, e.g., result in improved processibility and/or recovery in subsequent downstream processing steps.

The present disclosure also provides a use of the composite material of the present disclosure in the recovery of valuable materials from lithium ion batteries, e.g., from an intermediate lithium ion battery recycling material. In some embodiments, the composite materials are used as intermediates for a downstream leaching process.

For example, a black mass fraction comprising the composite material can be leached with an acidic aqueous solution comprising, e.g., sulfuric acid (H₂SO₄) to obtain a solution comprising one or more value metal ions. The solution comprising one or more value metal ions may be further purified via, e.g., solvent exchange, ion-exchange, precipitation, extraction, and/or electrolysis.

Without wishing to be bound by theory, it is believed that the composite material has beneficial properties for improving one or more downstream processes such as leaching.

For example, it is believed that the complete decomposition of the at least one fluoropolymer and the near complete conversion of the fluorine contained in the intermediate lithium ion battery recycling material to fluoride results in a composite material having favorable properties.

For instance, the composite material of the present disclosure leads to clear phase separation when it is dispersed in a solvent extraction reagent which is a mixture of 5-nonylsalicylaldoxime and 2-hydroxy-5-nonylacetophenone oxime in a high flash point hydrocarbon diluent (LIX® 984N, BASF SE), while composite materials featuring a ratio of total fluorine content to ionic fluorine (fluoride) content of more than 1.1 show strong crud formation. Without wishing to be bound by theory, it is hypothesized that crud formation is caused by the interplay of decomposed binder and silicon compounds present in the composite. The origin of the silicon compounds may be, for instance, Si and SiOₓ in anodes having high Li⁺ capacity, Si in coatings of separator foils, Si-containing adhesives or insulators in batteries, or passivating films on the current collectors that contain Si.

A further benefit is that no flotation additives are required in the downstream leaching process.

Also, it is believed that the embrittlement of the composite material may, e.g., result in smaller particles that have a more beneficial surface-to-volume ratio facilitating dissolution during acid leaching. The smaller particle size may additionally facilitate subsequent transport steps, such as conveying.

In some embodiments, the leaching process involves leaching the composite material to obtain at least one value metal chosen from nickel, cobalt, manganese, and combinations thereof; wherein the obtained at least one value metal has a purity of at least 80% by weight.

In some embodiments, the leaching process comprises contacting the composite material with an acidic aqueous solution having a pH less than 6. In an embodiment of the leaching process, the acidic aqueous solution comprises at least one acid chosen from hydrochloric acid (HCl), sulfuric acid (H₂SO₄), methane sulfonic acid, and nitric acid.

### Elemental Analysis

This section describes the analytical methods used for the quantitative determination of the constituents of the composite material of the present disclosure.

### Fluorine Content

The determination of fluorine uses a combination of combustion and measurement by a fluoride ion-selective electrode.

### Combustion

Approximately 1-100 mg of the sample were weighed into a combustion boat. For sample weighing and transfer, a capsule made of gelatine or tin can be used. V₂O₅ was added to promote the combustion. The boat was introduced via a sample application device into a combustion tube heated to ˜1.000-1.100° C. The sample was combusted in an oxygen stream containing water steam. During combustion, fluorine containing components formed hydrogen fluoride. The combustion gases, containing the formed hydrogen fluoride, were absorbed in an absorption solution. A total ionic strength adjustment buffer, (e.g., TISAB IV buffer solution (ASTM D 1179)) was used as absorption solution. The solution was transferred to the ion-sensitive measuring cell and filled up to 50 mL using TISAB and ultrapure water (1:1).

The combustion system used was a Mitsubishi AQF-2100H automatic quick furnace (a1-envirosciences GmbH, 40595 Düsseldorf, Germany).
Oven inlet temperature: ˜1.000° C.
Oven outlet temperature: ˜1.100° C.
Combustion gas (oxygen): ˜200 mL/min
Carrier gas (argon): ˜100 mL/min
Water flow: 0.2 mL/min

### Detection by Fluoride Ion-Selective Electrode

In the absorption solution, fluoride was measured by means of a fluoride ion-selective electrode (e.g., ISE 6.0502.150, Deutsche Metrohm GmbH & Co. KG, 70794 Filderstadt, Germany). For quantification, external calibration of the electrode was performed using fluoride standard solutions of different concentrations, e.g. 0.1, 1.0, 10 and 100 mg/L fluoride. The calibration solutions were automatically prepared by diluting a fluoride stock solution with TISAB solution and ultrapure water (1:1).

### Fluoride Content

The determination of fluoride uses detection by a fluoride ion-selective electrode following distillation with phosphoric acid.

### Sample Preparation

A distillation apparatus was filled with phosphoric acid (H₃PO₄ 85%, 50 mL), and approximately 200-2.000 mg of the sample were added. After heating up the apparatus to approximately 175° C., deionized water was added to hydrolyze the inorganic fluorides and transport them as hydrogen fluoride into a beaker containing a NaOH solution (1 mol/L, 80 mL). Distillation was stopped after a volume of approximately 400 mL had been collected in the beaker.

The solution was adjusted to a pH value of 5.26 using acetic acid or NaOH. In a volumetric flask, the solution was filled up to a volume of 500 mL using ultrapure water. An aliquot (25 mL) was transferred into a 50 mL volumetric flask, and 25 mL of a total ionic strength adjustment buffer solution (e.g. TISAB IV buffer solution) were added.

### Analysis

The detection of fluoride was performed by means of a fluoride ion-selective electrode (e.g. ISE 6.0502.150, Metrohm). For quantification, external calibration of the electrode was performed using fluoride standard solutions of different concentrations. The calibration solutions were obtained by diluting the fluoride stock solution with a solution containing TISAB and ultrapure water (1:1). The calibration solutions contained different fluoride concentrations, e.g., 0.1, 1.0, 10, and 100 mg/L, respectively.

### Metal Content

Elemental analysis was performed using a combination of acid dissolution and alkaline-borate fusion digestion with analysis by inductively coupled plasma optical emission spectrometry (ICP-OES) on an inductively coupled plasma optical emission spectrometer (e.g., Agilent 5110 ICP-OES, Agilent Technologies Germany Gmbh & Co. KG, 76337 Waldbronn, Germany).

An aliquot (e.g., about 0.2 g) of the sample material was weighed into a volumetric flask and dissolved under slight heating with 30 ml HCl. After cooling down, the insoluble residue was filtered out and incinerated together with the filter paper in a Pt crucible above an open flame. Subsequently, the residue was calcinated at about 600° C. in a muffle furnace and then mixed with 1.0 g of a K₂CO₃—Na₂CO₃/Na₂B₄O₇ flux mixture (4:1) and melted above an open flame until a clear melt was obtained. After cooling down, the melt cake was dissolved in deionized (DI) water under slight heating and 12 ml of HCl were added. Finally, the solution was joined to the initial filtered solution in the volumetric flask and topped up to its final volume with DI water. Each sample was prepared in triplicate. A blank sample was prepared in an analogous manner.

The digestion solution was analyzed by inductively coupled plasma-optical emission spectrometry (ICP-OES), using external calibration. For some samples, the digestion solution may be diluted before analysis, e.g., adapted to the concentration and calibration range of the respective analyte.

### Phosphorus Content

Phosphorus content was determined by a combination of acid dissolution and alkaline-borate fusion digestion with subsequent measurement via inductively coupled plasma optical emission spectrometry (ICP-OES).

An aliquot between 0.13 g and 0.18 g of the sample material was weighed into a volumetric flask and dissolved under slight heating with HCl (approx. 6 mol/l). After cooling down, the insoluble residue was filtered out and incinerated together with the filter paper in a Pt crucible above an open flame. Subsequently, the residue was calcinated at approx. 600° C. in a muffle furnace and then mixed with 1.0 g of a K₂CO₃—Na₂CO₃/Na₂B₄O₇ flux mixture (4:1) and melted above an open flame until a clear melt was obtained. After cooling down, the melt cake was dissolved in DI water under slight heating and 12 ml of HCl were added. Finally, the solution was joined to the initial filtered solution in the volumetric flask and the volume was completed to 100 ml with DI water. Each sample was prepared in triplicate. A blank sample was prepared in an analogous manner.

The digestion solution was analyzed by inductively coupled plasma-optical emission spectrometry (ICP-OES) using and ICP-OES spectrometer (Agilent 5110 ICP-OES, Agilent Technologies Germany Gmbh & Co. KG, 76337 Waldbronn, Germany) at wavelength: P (R) 178.222 nm, internal standard: Sc (R) 361.383 nm, Calibration: External, Dilution: 1 (direct measurement).

### Carbon Content

Carbon content was determined by elemental analysis in an automated analyzer (vario EL Cube, Elementar Analysensysteme GmbH, 63505 Langenselbold, Germany). The sample (2-3 mg) was weighed into a tin capsule. The capsule with the sample was combusted in a helium/oxygen atmosphere at approximately 1100° C. using copper oxide as combustion catalyst. After separation of the combustion gases via chromatography, carbon was determined as CO₂. The detection and quantification was performed via measurement of thermal conductivity using a TCD.

### Particle Size Distribution

Particle size distribution was measured by dispersing a sample of the material in water comprising a non-ionic surfactant and measuring the dispersion in a laser diffraction particle size analyzer (Mastersizer® 3000, Malvern Panalytical GmbH, 34123 Kassel, Germany) coupled to an automated dispersion unit (Hydro MV, Malvern Panalytical GmbH, 34123 Kassel, Germany). The sample was dispersed in 120 ml water comprising 1-2 ml of a polyethylene glycol ether (0.5 wt.-% solution of Lutensol® XL 80, BASF SE), stirring at 3,500 rpm and using 2 min of ultrasound sonification.

### Thermogravimetric Analysis (TGA)

Thermogravimetric analysis was performed using a thermogravimetric analyzer SDT Q600 V20.9 Build 20 (TA Instruments, New Castle, DE 19720, USA). A sample of ˜18 mg composite material was heated to 575° C. and 650° C., respectively, at a heating rate of 20 K/h. Sample mass was continuously measured while the temperature of the sample was changed.

### EXAMPLES

The following examples are intended to be illustrative and are not meant in any way to limit the scope of the disclosure.

### Comparative Example 1*, Examples 1-4

Samples were prepared as follows. First, an intermediate lithium ion battery recycling material comprising a cathode active material was provided at a first temperature (Tₛₜₐᵣₜ). The material contained 12.5 wt % Ni, 5 wt % Co, 4.5 wt % Mn, 2.7 wt % Li, 0.5 wt % P, and 38.9 wt % C, relative to the total weight of the material. Second, the intermediate lithium ion battery recycling material was heated by a temperature ramp from the first temperature to the second temperature T_{dwell}. Third, the intermediate lithium ion battery recycling material dwelled at the second temperature for a time. The material was contacted with an inert gas and a reductive gas generated in situ by thermal decomposition of the intermediate lithium ion battery recycling material to obtain the composite material. Fourth, the composite material was cooled to ambient temperature. Details for each example are provided in Table 1.

TABLE 1

| | Example # | | | | |
|---|---|---|---|---|---|
| | 1* | | | | |
| | (comparative) | 1 | 2 | 3 | 4 |
| Sample weight [g] | 300 | 200 | 100 | 100 | 100 |
| Tₛₜₐᵣₜ [° C.] | 20 | 20 | 25 | 25 | 25 |
| T_{dwell} [° C.] | 500 | 550 | 520 | 540 | 560 |
| Ramp time [min] | 50 | 50 | 50 | 50 | 50 |
| Dwell time [min] | 30 | 30 | 10 | 10 | 10 |
| Fᵢₒₙ [wt.-%] | 2.6 | 2.8 | 2.30 | 2.37 | 2.40 |
| Fₜₒₜₐₗ [wt.-%] | 3.1 | 2.8 | 2.37 | 2.40 | 2.40 |
| Fₜₒₜₐₗ/Fᵢₒₙ | 1.19 | 1.0 | 1.03 | 1.01 | 1.00 |

### Comparative Example 5*

Samples were prepared as follows. First, an intermediate lithium ion battery recycling material comprising a cathode active material was provided at a first temperature (Tₛₜₐᵣₜ). The material contained 10 wt % Ni, 10.3 wt % Co, 7.2 wt % Mn, 3.8 wt % Li, 0.59 wt % P, and 28.7 wt % C, relative to the total weight of the material. Second, the intermediate lithium ion battery recycling material was heated by a temperature ramp from the first temperature to the second temperature T_{dwell}. Third, the intermediate lithium ion battery recycling material dwelled at the second temperature for a dwell time. The material was contacted with an inert gas and a reductive gas generated in situ by thermal decomposition of the intermediate lithium ion battery recycling material to obtain the composite material. Fourth, the composite material was allowed to cool down to ambient temperature under inert gas atmosphere. Details are provided in Table 2.

### Example 6

The product obtained in Comparative Example 5 was heated by a temperature ramp from ambient temperature (Tₛₜₐᵣₜ) to a second temperature T_{dwell} and dwelled at the second temperature for a dwell time. The material was contacted with an inert gas and a reductive gas generated in situ by further thermal decomposition of the composite material. The composite material then was allowed to cool down to ambient temperature. Details are provided in Table 2.

### Comparative Example 7*

Samples were prepared as follows. First, an intermediate lithium ion battery recycling material comprising a cathode active material was provided at a first temperature (Tₛₜₐᵣₜ). The material contained 14.5 wt % Ni, 7.5 wt % Co, 4.5 wt % Mn, 3.5 wt % Li, 0.67 wt % P, and 34.5 wt % C, relative to the total weight of the material. Second, the intermediate lithium ion battery recycling material was heated by a temperature ramp from the first temperature to the second temperature T_{dwell}. Third, the intermediate lithium ion battery recycling material dwelled at the second temperature for a dwell time. The material was contacted with an inert gas and a reductive gas generated in situ by thermal decomposition of the intermediate lithium ion battery recycling material to obtain the composite material. Fourth, the composite material was allowed to cool down to ambient temperature under inert gas atmosphere. Details are provided in Table 2.

### Example 8

The product obtained in Comparative Example 7 was heated by a temperature ramp from ambient temperature (Tₛₜₐᵣₜ) to a second temperature T_{dwell}. The material was contacted with an inert gas and a reductive gas generated in situ by further thermal decomposition of the composite material. The composite material then was allowed to cool down to ambient temperature under inert gas atmosphere. Details are provided in Table 2.

TABLE 2

| | Example # | | | |
|---|---|---|---|---|
| | 5* | | 7* | |
| | (comparison) | 6 | (comparison) | 8 |
| Tₛₜₐᵣₜ [° C.] | 25 | 25 | 25 | 25 |
| T_{dwell} [° C.] | 480 | 570 | 500 | 570 |
| Ramp time [min] | 15 | 50 | 15 | 50 |
| Dwell time [min] | 30 | 60 | 30 | 0 |
| Fᵢₒₙ [wt.-%] | 2.6 | 2.9 | 3.0 | 3.2 |
| Fₜₒₜₐₗ [wt.-%] | 3.8 | 3.0 | 4.0 | 3.4 |
| Fₜₒₜₐₗ/Fᵢₒₙ | 1.46 | 1.03 | 1.33 | 1.06 |

### TGA

The products obtained in Examples 2 and 4, Comparative Examples 5* and 7*, and Examples 6 and 8 were subjected to thermogravimetric analysis (TGA) as described above. Weight loss at 575° C. and 650° C. was determined for each composite material. The results are shown in Table 3.

TABLE 3

| | Weight loss | Weight loss |
|---|---|---|
| | at 575° C. | at 650° C. |
| Example # | [%] | [%] |
| 2 | 2 | 3 |
| 4 | 1 | 2 |
| 5* (comparative) | 4 | 6 |
| 6 | 1 | 2 |
| 7* (comparative) | 3 | 5 |
| 8 | 2 | 3 |

### Leaching

Samples of the products obtained in the above examples were leached with sulfuric acid as follows: 20 g of the product were dispersed in 65 g deionized water and heated to 90° C. under stirring. 29 g of 96% sulfuric acid were slowly added within 15 minutes. After 2 h at 90° C., the mixture was allowed to cool to ambient temperature and then filtrated to remove the solids. The filter cake was washed with 20 ml deionized water.

### Phase Separation Test

20 ml of kerosene (Exxol® D80) were added to 40 ml of the filtrate. The mixture was shaken vigorously for 1 min to form an emulsion, and subsequently the time needed for phase separation was measured.

For the emulsions prepared from the product obtained in Examples 1-4, 6, and 8, complete phase separation occurred within 1 minute, while the emulsions prepared from the products obtained in Comparative Examples 1, 5, and 7 were stable for several days.

1. A composite material comprising lithium, fluorine, and at least one of nickel, cobalt, manganese, and iron, wherein the composite material has a fluorine content of from 1 to 10 wt. %, relative to the total weight of the composite material, and the ratio of total fluorine content to ionic fluorine (fluoride) content is less than 1.1.

2. The composite material of claim 1, which further comprises aluminum, and/or copper, and/or carbon, and/or phosphorus.

3. The composite material of claim 1, further comprising from 0 to 45 wt. % nickel, based on the total weight of the composite material.

4. The composite material of claim 1, comprising from 0 to 45 wt. % cobalt, based on the total weight of the composite material.

5. The composite material of claim 1, comprising from 0 to 45 wt. % manganese, based on the total weight of the composite material.

6. The composite material of claim 1, comprising from 2 to 6 wt. % lithium, based on the total weight of the composite material.

7. A process for preparing the composite material of claim 1, comprising
a) providing an intermediate lithium ion battery recycling material comprising a cathode active material (CAM) and at least one fluoropolymer at a first temperature;
b) heating the intermediate lithium ion battery recycling material at a second temperature ranging from 520° C. to 630° C.;
c) contacting the intermediate lithium ion battery recycling material with an inert gas and with a reductive gas generated in situ by thermal decomposition of the intermediate lithium ion battery recycling material to obtain the composite material; and
d) optionally, cooling the composite material to a third temperature ranging from 10° C. to 100° C.

8. The process of claim 7, wherein the at least one fluoropolymer comprises polyvinylidene fluoride (PVDF).

9. The process of claim 7, wherein the at least one fluoropolymer comprises polytetrafluoroethylene (PTFE).

10. The process of claim 7, wherein the cathode active material is of formula LiₚM_{q}M′ᵣOₛ; wherein:
M comprises one or more metals selected from the group consisting of nickel, manganese, and cobalt,
M′ comprises one or more metals selected from the group consisting of Mg, Ca, Ba, Al, Ti, Zr, Zn, Fe, V, Mo and W;
p ranges from 1 to 1.4;
q ranges from 0.6 to 2;
r ranges from 0 to 1; and
s ranges from 2 to 4.

11. The process of claim 7, wherein the heating step b) comprises a temperature ramp from the first temperature to the second temperature over a period of 10 minutes to 2 hours.

12. The process of claim 7, wherein the heating step b) comprises dwelling at the second temperature for a period of time ranging from 0 minutes to 1 hour.

13. The process of claim 7, wherein the heating step b) is performed in a rotary kiln.

14. The process of claim 13, wherein the intermediate lithium ion battery recycling material and an inert gas are fed to the rotary kiln in a co-current flow.

15. A method of using the composite material of claim 1, the method comprising using the composite material in the recovery of valuable materials from lithium ion batteries.
